(19) United States
(12) Patent Application Publication
(10) Pub. No.: US 2023/0324873 A1
(43) Pub. Date: Oct. 12, 2023

(54) Systems and Methods for Improving Workplace Safety Via Machine Learning Applied to Lidar and Vision Systems Deployed in a Workplace

(71) Applicant: Keith Douglas Bowers, Phoenix, AZ (US)

(72) Inventor: Keith Douglas Bowers, Phoenix, AZ (US)

(21) Appl. No.: 18/133,982

(22) Filed: Apr. 12, 2023

Related U.S. Application Data
(60) Provisional application No. 63/330,067, filed on Apr. 12, 2022.

(51) Int. Cl. G05B 19/406

(52) U.S. Cl. CPC G05B 19/406; G05B 2219/50193

(57) ABSTRACT

Systems and methods are described for identifying and reducing workplace safety risks using computer vision, lidar, and machine learning. Sensor information is transferred to an AI server that identifies people, objects, powered industrial vehicles and other items of interest along with their locations over time. This information is gathered to identify infrequent but dangerous situations that may lead to serious and fatal accidents, such forklift collisions with human workers. This data may be used, for example, to identify near miss situations and allow safety personnel to institute risk mitigation measures, and/or to train an AI/ML model to predict the travel paths of moving objects in real time and warn workers of impending potential collisions and other dangerous situations.

### CROSS REFERENCE TO RELATED APPLICATIONS

This application claims the benefit of U.S. Provisional Patent Application No. 63/330,067, entitled COMPUTER VISION SYSTEMS AND METHODS FOR IMPROVING WORKPLACE SAFETY VIA MACHINE LEARNING, which was filed Apr. 12, 2022, the entire contents of which are hereby incorporated by reference.

### TECHNICAL FIELD

The present invention relates, generally, to systems and methods for reducing workplace safety risks and, more particularly, to using computer vision, lidar, and machine learning techniques for identifying potentially dangerous workplace situations that might lead to serious or fatal workplace accidents.

### BACKGROUND

Currently known methods for predicting and preventing serious workplace-related injuries are unsatisfactory in several respects. For example, despite recent advances in technology, there are no comprehensive techniques for identifying situations that could lead to serious injuries. For example, it is difficult to identify near miss or close call situations in a warehouse containing powered industrial vehicles workers and inventory, mainly due to a lack of information about the dangers of a given setting. Without copious information about movements and activities and their variation over time, it is not possible to identify many risky situations that warrant risk reduction measures. Current approaches to reducing safety in risk warehouse situations, for example, rely mainly upon a human observer noting traffic patterns for a few hours. This is insufficient to understand infrequent and risky situations such as near misses and other dangerous situations. Other methods for understanding workplace risks, such as reporting of near misses suffer from reporting bias and provide incomplete data.

Systems and methods are therefore needed that overcome these and other limitations of the prior art.

### SUMMARY OF THE INVENTION

Various embodiments of the present invention relate to systems and methods for identifying potentially dangerous workplace situations to thereby reduce workplace safety risks using a novel computer vision, lidar, and machine learning system. The system gathers image, point-clouds, and location data using a variety of cameras and sensors and then transfers this information to an AI server that identifies people, objects, powered industrial vehicles and other items of interest along with their locations while tracking the time. This information is gathered over long periods of time to gather sufficient information to identify the infrequent but dangerous situations that lead to serious and fatal accidents like forklift collisions with workers. This data is used for two purposes: (1) to identify near miss situations and allow safety personnel to institute risk mitigation measures, and (2) to train an AI model to predict the travel paths of moving objects in real time and warn workers of impending potential collisions and other dangerous situations.

### BRIEF DESCRIPTION OF THE DRAWING FIGURES

The present invention will hereinafter be described in conjunction with the appended drawing figures, wherein like numerals denote like elements, and:

FIG. 1 is a conceptual block diagram in accordance with one embodiment of the present invention;

FIG. 2 illustrates the use of a dashboard in accordance with various aspects of the invention;

FIG. 3 illustrates the use of traffic survey data for future use in training an AI path prediction model;

FIG. 4 illustrates a workplace safety architecture in accordance with one embodiment;

FIG. 5 illustrates a workplace useful in describing the present invention; and

FIG. 6 illustrates a dashboard and user interface in accordance with the present invention.

### DETAILED DESCRIPTION OF PREFERRED

### Exemplary Embodiments

As a preliminary matter, it will be understood that the following detailed description is merely exemplary in nature and is not intended to limit the inventions or the application and uses of the inventions described herein. Furthermore, there is no intention to be bound by any theory presented in the preceding background or the following detailed description. In the interest of brevity, conventional techniques and components related to computer vision, lidar systems, location sensing, data analytics, workplace safety issues, database systems, and the like need not be described herein.

Various embodiments of the present invention relate to systems and methods for identifying potentially dangerous workplace situations to thereby reduce workplace safety risks using a novel computer vison and machine learning system. In general, as further described below, the process begins with the collection of time-stamped images and location data gathered by one or more smart edge devices (e.g., optical cameras, infrared cameras, lidar devices, radar, ultrasonic, or the like) in the area of interest, for example, a product warehouse or loading dock. The smart edge device identifies objects and people of interest and calculates their location in real time. That is, the smart edge device preferably performs both object detection and object identification. In some embodiment, however, this functionality is distributed across multiple components. The resulting data is fed into a database that is used to train collision prediction models. The collision prediction model is trained for the activities of a specific area to provide better predictions based on the particular location. Additional data is used to update the AI models to improve model quality and reduce model drift.

When dangerous situations are predicted by the collision prevention model, appropriate warnings are issued. For example, if a path prediction model predicts that a powered industrial vehicle and a worker are likely to be in unsafe proximity within a few moments, an alarm is sounded, and a brake or speed restraint can be applied to the vehicle. This serves to reduce and prevent many collisions and near collisions that result in serious injuries and fatalities. The foregoing example is not intended limit the invention with respect to either (a) the source of the warning, (b) the content of the warning, or (c) the method used to transmit the warning. For example, the warning may originate from a central warning system located in the environment or from an object that is being tracked within the environment (e.g., a forklift, a wearable device, etc.). More broadly, the warning may be targeted at a human or humans within the environment, or may be targeted at the actual machinery operating in the environment (e.g., to deactivate a device to prevent a dangerous situation).

In order to access and better understand this data to improve safety and other workplace processes a “viewer dashboard” is used. The viewer dashboard has several key components. One component is a video viewer, another is a series of filters so that the user can extract video clips of interest and identify appropriate video segments of interest. For example, a user interested in improving safety could identify situations where a powered industrial vehicle exceeded speed limits or other rules. Since we have location data along with the corresponding time, we can calculate speed, acceleration, and other physical and dynamic/kinematic parameters to ensure workplace compliance on a continuous basis. In addition, the viewer can be used to identify other near miss situations and ensure and monitor compliance of safety and other workplace rules.

In addition to the video viewer, the viewer/dashboard contains a traffic pattern heat map viewer. This presents graphical summary of traffic patterns and or near miss situations. For example, a user can adjust the various filters (speed, distance between people and vehicles, number of people present, and other filters) to extract from the video database the video clips that show the traffic patterns when forklifts and people are within, say, five feet in each other in order to better understand traffic flow in dangerous situations and institute additional preventive measures.

In addition to the obvious safety benefits of the system, it can easily be used for other be used to improve other workplace processes. For example, object location data can be used to track warehouse product flow patterns for quality and efficiency, and computer vision techniques can be used to monitor product quality. For example, the invention might track product dimensions or other visual or location related parameters to ensure product quality. Once the system is set up it's easy to add additional computer vision models that can greatly expand the capabilities of the system. For example, models to identify unauthorized employees in dangerous locations could be added to the invention.

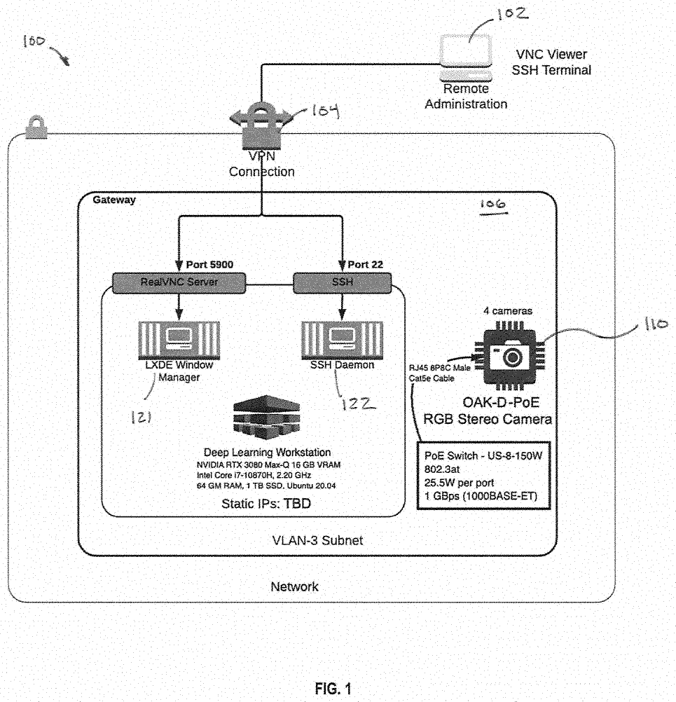

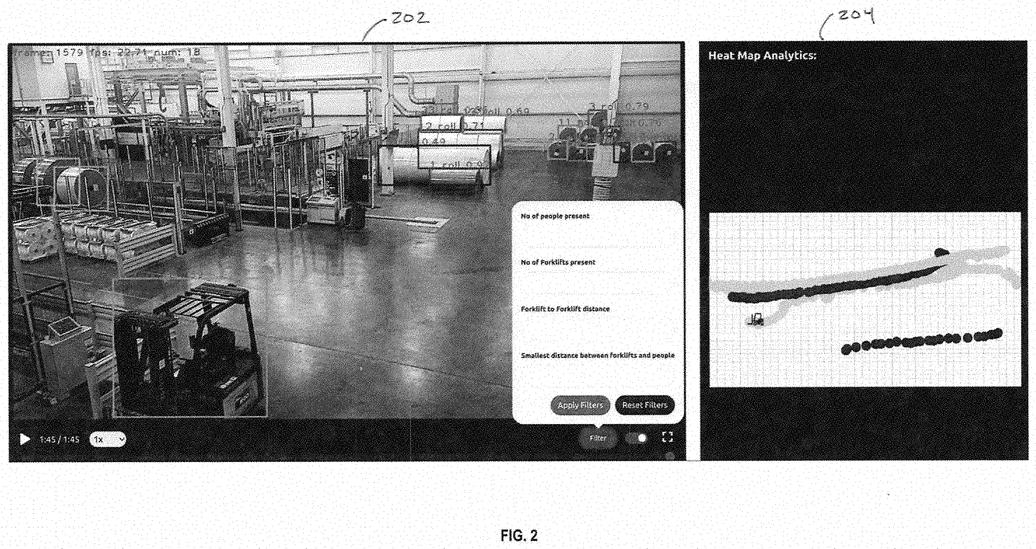

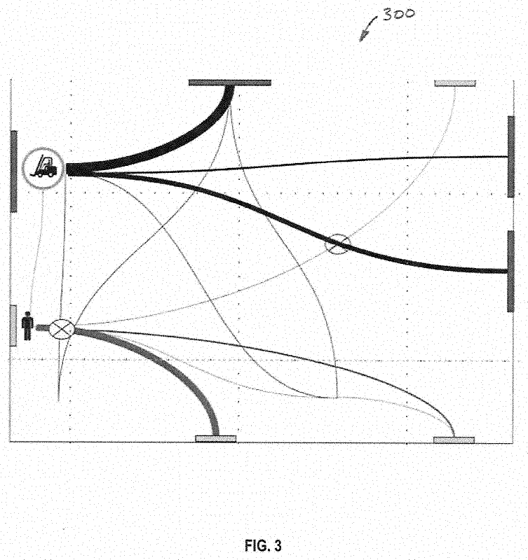

Turning now to the figures, FIG. 1 is a conceptual block diagram in accordance with one embodiment of the present invention, FIG. 2 illustrates the use of a dashboard in accordance with various aspects of the invention, and FIG. 3 illustrates the use of traffic survey data for future use in training an AI path prediction model.

More particularly, as shown in FIG. 1, the system 100 generally includes a viewer (e.g., VNC Viewer SSH Terminal) 102 that operates as a remote administrator, coupled through a VPN connection 104 to a network and gateway 106, as illustrated. The network includes one or more cameras or other sensors 110 (e.g., an OAK-D-PoE RGB Stereo Camera or suitable lidar component) and a deep learning workstation (including, in this embodiment, a LXDE Window Manager 121 and SSH Daemon 122), all of which are accessible via the remote administrator system.

As depicted in FIG. 2, the admin (or other user) may monitor the behavior of objects in the environment through a viewer, having a user interface as shown. In the illustrated embodiment, the viewer includes a live view 202 of the environment (left), including humans, objects, and vehicles within the environment, which (in this example) are indicated by bounding rectangles to indicate that those objects have been detected and/or identified. Also shown is a form of “heat map” 204 (right) in which indicates, in the form of trails, the position of those objects over time (and possible near-collisions between those objects).

As shown, the user may apply filters to change the criteria used for displaying the heat map analytics display portion. For example, such filters may include: number of people present, number of forklifts present, forklift-to-forklift distance, and minimum distance between forklifts and people, and the like. This list of filters is not intended to be exhaustive, and any number of such filters may be used and configured depending upon context.

As shown in FIG. 3, the accumulated path data (300) may be used for training an AI path prediction model. That is, the AI System (shown in FIG. 1) may determine the most likely paths taken by objects in the environment and then use that data to determine maximum-likelihood paths (and possible collisions and other workplace accidents) within the environment.

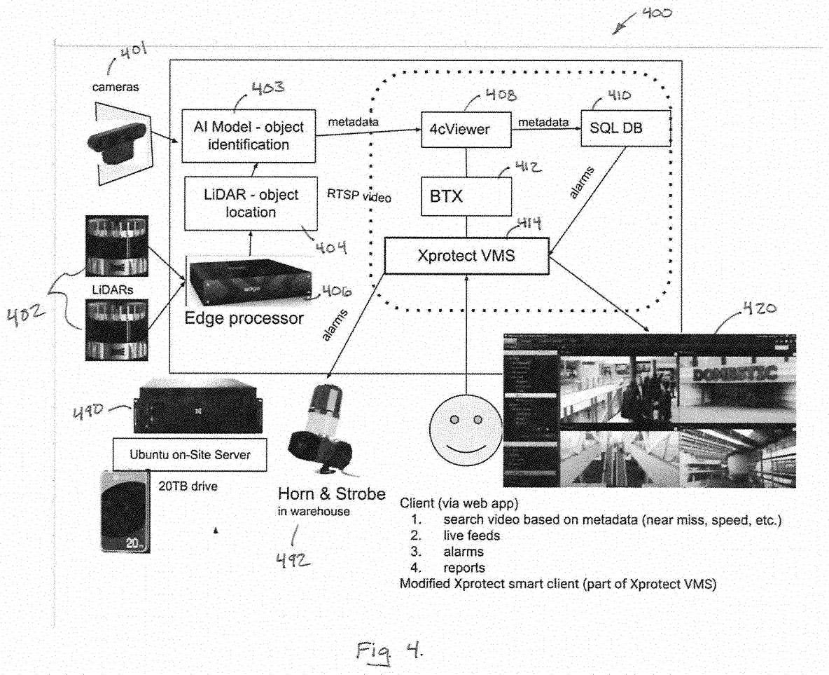

FIG. 4 illustrates an alternative embodiment that incorporates lidar sensors in a novel manner. More particularly, a system 400 includes one or more optical cameras 401 and two or more lidar sensors (or simply “lidars”) 402, configured in a particular manner relative to the environment (as described further below). The system 400 also includes an edge processing system 406 as is known in the art (coupled to lidars 402), an AI model-objection identification module 403, a lidar object location module 404, a viewer 408 configured to receive metadata from module 403, a database (e.g., SQL DB) 410, a BTX or other comparable module 412, a VMS system 414, and a dashboard or other GUI 420. Also included are one or more alarm systems, such as a horn & strobe 492 known in the art.

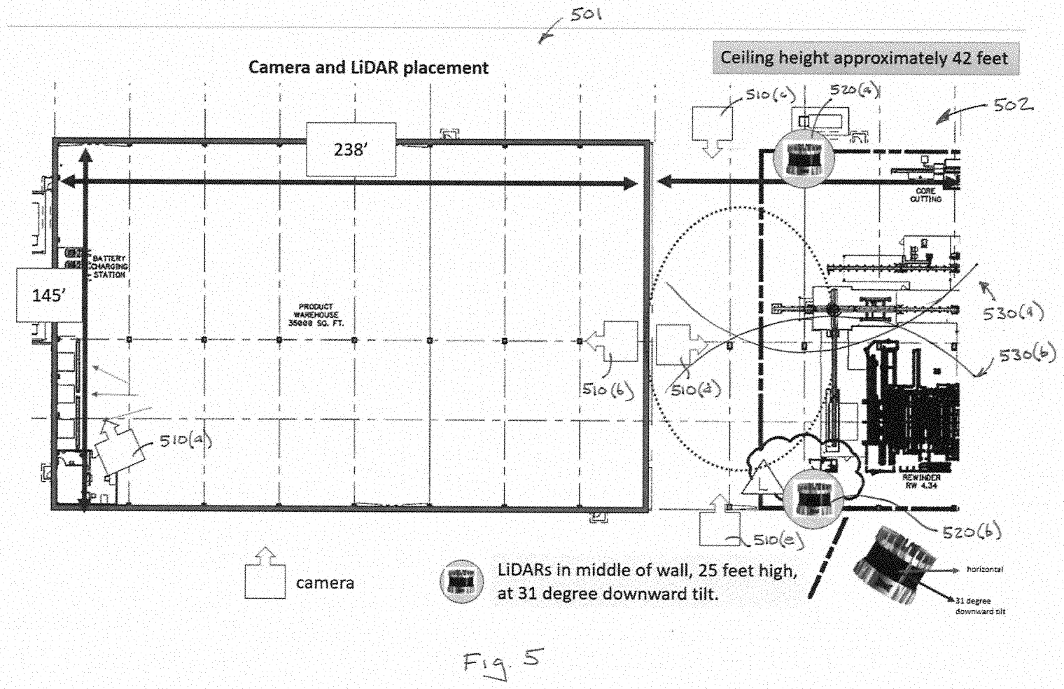

FIG. 5 illustrates an example top-down view of a workplace environment (e.g., a product warehouse region) comprising a first portion 501 and a second portion 502. In the first portion 501, two optical cameras (510(a) and (b)) are provided, oriented as shown. In the second portion, 502, three optical cameras (510(c), (d), and (e)) are provided, accompanied by a pair of lidar sensors 520(a) and 520(b).

In one embodiment, lidar sensors 520 are positioned in an antipodal manner with respect to each other—i.e., directly across from each other, facing inward along some axis of the region 502. The lidar sensors 520 have corresponding effective ranges 530, which intersect toward the middle of the region (as shown). It will be understood that the illustrated overlap and geometries shown in FIG. 5 are not intended to be limiting. In one embodiment, the lidar sensors are oriented to face downward at an angle of about 30-35 degrees (relative to horizontal), and are positioned about 20-30 feet high relative to the floor or bottom surface.

In some embodiments, each lidar sensor 520 has a corresponding optical camera 510 facing in substantially the same direction as the lidar sensor. That is, optical camera 510(c) may be co-positioned with lidar sensor 520(a), and optical camera 510(e) may be co-positioned with lidar sensor 520(b). Preferably, the cameras and lidar sensors are aligned such that they are facing the same general region (i.e., their orientations are coincident).

By positioning the lidar sensors 520 in this way, the system 400 (which can synthesize the positions derived from multiple optical and lidar sensors) is able to accurately determine the position of objects in the environment, as coverage is increased. That is, for example, if a fork-lift moves away from lidar sensor 520(a) and toward 520(b), then 520(b) will still be capable of determining with great accuracy the location of that object, even though lidar 520(a) may not be able to do so (due to the distance and dispersion of the laser scanner).

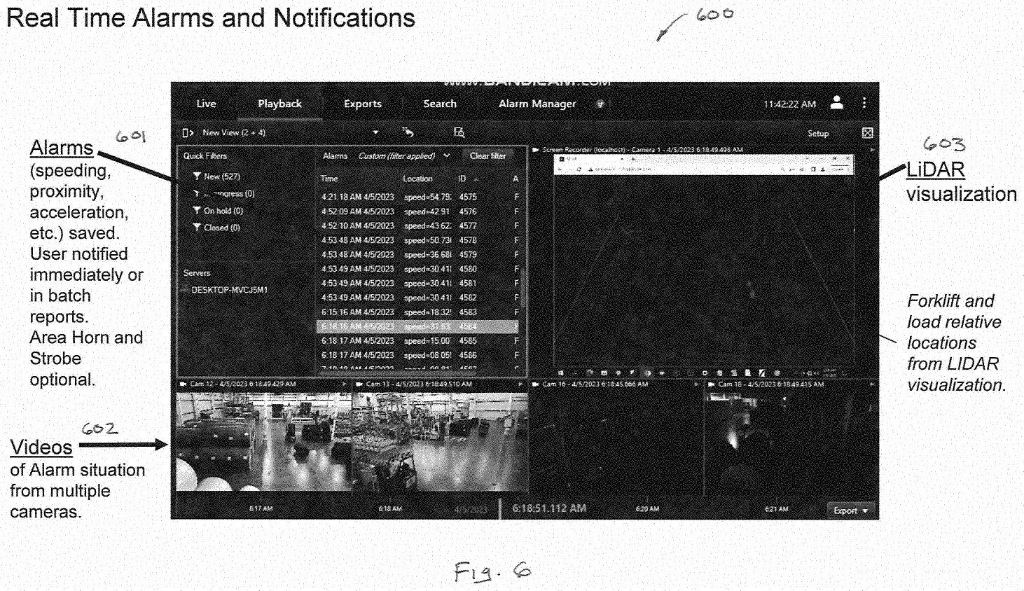

FIG. 6 illustrates an example dashboard capable of providing a user interface that can be intuitively interpreted and operated by an individual. This user interface may be provided by any of the processors shown in FIG. 4, such as VMS system 414.

With continued reference to FIG. 6, the user interface 600 is configured with an alarm region 601, a video region 602, and a lidar visualization region 603. Alarm section 601 includes a list of alarms that are generated in accordance with user-generated parameters, such as speeding proximity, acceleration, and the like). Video region 602 allows the user to simultaneously view videos of the associated alarms (listed in region 601), while lidar visualization region 603 allows the associated detailed lidar information to be viewed by the user. In this, way, the operator can derive significant, actionable information regarding possible dangers in the environment, and will be able to more meaningfully craft corrective actions.

In accordance with one aspect of the present invention, custom rules are used (by system 400) to reduce false alarms. That is, frequent false alarms can distract and annoy workers, and can actually cause collision prevention systems to be abandoned. The present system is configured to track and record every movement with centimeter-level accuracy using overlapping lidar coverage (as described above). The system thus may use the accumulated object flow data to detect near misses and hot spots, so that lower-risk situations do not result in an alarm. For example, a speed limit for forklifts might normally be 10 mph, but may be lowered to 5 mph when a pedestrian is within 75 feet of the forklift. Alternatively, the alarm distance between a vehicle and person could be reduced in an area with previous near misses.

In accordance with another embodiment, vehicle and/or pedestrian (human) orientations are used to infer the human field of view. That is, the pedestrian field of view may be inferred from highly accurate heading and orientation data from the lidar. Vehicles approaching a pedestrian's blind side cause alarms sooner than vehicles approaching within main area of focus. Similarly, vehicles backing cause alarms sooner that vehicles moving forward.

Warnings may be associated with a variety of risk events, including collisions, traffic analytics, over-speed, over-acceleration (positive or negative), smart danger zone (function of speeding and heading), 3D restricted zones (people, vehicles, on-way zone), machine guarding (people within 3D zone), and the like. Computer vision may also be used (even without lidar info), such as slip/fall detection, unconscious worker detection, PPE compliance, fire/smoke, fighting, group detection, weapon detection, vandalism detection, running people, people or vehicles moving the wrong direction, blocked aisle-way, and other ergonomic models.

The system is described herein in terms of functional and/or logical block components and various processing steps. It should be appreciated that such block components may be realized and implemented by any number of hardware, software, and/or firmware components configured to perform the specified functions. For example, an embodiment of the present disclosure may employ various stand-alone computing devices, software-as-a-service (SaaS), platform-as-a-service (PaaS), or infrastructure-as-a-service (IaaS) systems, integrated circuit components, digital signal processing elements, field-programmable gate arrays (FPGAs), Application Specific Integrated Circuits (ASICs), logic elements, look-up tables, network interfaces, or the like, which may carry out a variety of functions under the control of one or more microprocessors or other control devices either locally or in a distributed manner.

The various functional modules described herein may be implemented entirely or in part using a machine learning or predictive analytics model. In this regard, the phrase “computer vision or AI” model is used without loss of generality to refer to any result of an analysis that is designed to make some form of prediction, such as predicting the state of a response variable, clustering words, determining association rules, and performing anomaly detection. Thus, for example, the term “machine learning” refers to models that undergo supervised, unsupervised, semi-supervised, and/or reinforcement learning.

Such models may perform classification (e.g., binary or multiclass classification), regression, clustering, dimensionality reduction, and/or such tasks. Examples of such models include, without limitation, large language modules (e.g., GPTx), artificial neural networks (ANN) (such as a deep learning networks, recurrent neural networks (RNN), and convolutional neural networks (CNN)), decision tree models (such as classification and regression trees (CART)), ensemble learning models (such as boosting, bootstrapped aggregation, gradient boosting machines, and random forests), Bayesian network models (e.g., naive Bayes), principal component analysis (PCA), support vector machines (SVM), clustering models (such as K-nearest-neighbor, K-means, expectation maximization, hierarchical clustering, etc.), linear discriminant analysis models, and time-series analysis (such as simple moving average (SMA) models, autoregressive integration moving average (ARIMA) models, and generalized autoregressive conditional heteroskedasticity (GARCH) models.

Any data generated by the above systems may be stored and handled in a secure fashion (i.e., with respect to confidentiality, integrity, and availability). For example, a variety of symmetrical and/or asymmetrical encryption schemes and standards may be employed to securely handle data at rest and in motion. Without limiting the foregoing, such encryption standards and key-exchange protocols might include Triple Data Encryption Standard (3DES), Advanced Encryption Standard (AES) (such as AES-128, 192, or 256), Rivest-Shamir-Adelman (RSA), Twofish, RC4, RC5, RC6, Transport Layer Security (TLS), Diffie-Hellman key exchange, and Secure Sockets Layer (SSL). In addition, various hashing functions may be used to address integrity concerns associated with the data.

In summary, what has been described is a workplace safety system comprising: at least one optical camera positioned to observe a workplace region; at least two lidar sensors positioned to observe the workplace region; an object location module communicatively coupled to the lidar sensors and configured to determine the location of one or more objects in the workplace region; an object identification module communicatively coupled to the object location module and configured to identify the type of the one or more objects and to produce metadata associated therewith; a processing system configured to process the metadata to determine the existence of risk events associated with the movement of the objects in the workplace region; a dashboard system configured to receive the metadata and provide a list of the risk events; and simultaneously display video received from the at least one optical camera and lidar information from at least one of the lidar sensors for a selected risk event.

A method of increasing workplace safety, the method comprising: providing at least one optical camera positioned to observe a workplace region; providing at least two lidar sensors positioned to observe the workplace region; determining, via an object location module communicatively coupled to the lidar sensors, the location of one or more objects in the workplace region; identifying the type of the one or more objects and to produce metadata associated therewith; processing the metadata to determine the existence of risk events associated with the movement of the objects in the workplace region; receiving, with a user-viewable dashboard system, the metadata, and providing a list of the risk events; and simultaneously display video received from the at least one optical camera and lidar information from at least one of the lidar sensors for a selected risk event.

In addition, those skilled in the art will appreciate that embodiments of the present disclosure may be practiced in conjunction with any number of systems, and that the systems described herein are merely exemplary embodiments of the present disclosure. Further, the connecting lines shown in the various figures contained herein are intended to represent example functional relationships and/or physical couplings between the various elements. It should be noted that many alternative or additional functional relationships or physical connections may be present in an embodiment of the present disclosure.

As used herein, the terms “module” or “controller” refer to any hardware, software, firmware, electronic control component, processing logic, and/or processor device, microprocessor, open source computing platform, general purpose computer, individually or in any combination (either distributed or consolidated in one component), including without limitation: application specific integrated circuits (ASICs), field-programmable gate-arrays (FPGAs), dedicated neural network devices (e.g., Google Tensor Processing Units), electronic circuits, processors (shared, dedicated, or group) configured to execute one or more software or firmware programs, a combinational logic circuit, and/or other suitable components that provide the described functionality.

As used herein, the word “exemplary” means “serving as an example, instance, or illustration.” Any implementation described herein as “exemplary” is not necessarily to be construed as preferred or advantageous over other implementations, nor is it intended to be construed as a model that must be literally duplicated.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

1. A workplace safety system comprising:
at least one optical camera positioned to observe a workplace region;
at least two lidar sensors positioned to observe the workplace region;
an object location module communicatively coupled to the lidar sensors and configured to determine the location of one or more objects in the workplace region;
an object identification module communicatively coupled to the object location module and configured to identify the type of the one or more objects and to produce metadata associated therewith;
a processing system configured to process the metadata to determine the existence of risk events associated with the movement of the objects in the workplace region;
a dashboard system configured to receive the metadata and provide a list of the risk events; and simultaneously display video received from the at least one optical camera and lidar information from at least one of the lidar sensors for a selected risk event.

2. The workplace safety system of claim 1, wherein the lidar sensors include two lidar sensors positioned at opposite ends of the workplace region, aligned along a central axis, such that their fields of view overlap.

3. The workplace safety system of claim 1, wherein the lidar sensors are oriented at a 30-35 angle downward with respect to the horizontal plane.

4. The workplace safety system of claim 1, wherein the risk events are user-configured.

5. The workplace safety system of claim 1, wherein false alarms associated with the risk events are reduced via custom rules.

6. The workplace safety system of claim 5, wherein the custom rules include consideration of the human field of view.

7. The workplace safety system of claim 1, further including generating an audible alarm in the workplace region when a predefined risk event occurs.

8. The workplace safety system of claim 1, further including generating a heat map associated with the risk events.

9. A method of increasing workplace safety, the method comprising:
providing at least one optical camera positioned to observe a workplace region;
providing at least two lidar sensors positioned to observe the workplace region;
determining, via an object location module communicatively coupled to the lidar sensors, the location of one or more objects in the workplace region;
identifying the type of the one or more objects and to produce metadata associated therewith;
processing the metadata to determine the existence of risk events associated with the movement of the objects in the workplace region;
receiving, with a user-viewable dashboard system, the metadata, and providing a list of the risk events; and simultaneously display video received from the at least one optical camera and lidar information from at least one of the lidar sensors for a selected risk event.

10. The method of claim 9, wherein the lidar sensors include two lidar sensors positioned at opposite ends of the workplace region, aligned along a central axis, such that their fields of view overlap.

11. The method of claim 9, wherein the lidar sensors are oriented at a 30-35 angle downward with respect to the horizontal plane.

12. The method of claim 9, wherein the risk events are user-configured.

13. The method of claim 9, wherein false alarms associated with the risk events are reduced via custom rules.

14. The method of claim 13, wherein the custom rules include consideration of the human field of view.

15. The method of claim 9, further including generating an audible alarm in the workplace region when a predefined risk event occurs.

16. The method of claim 9, further including generating a heat map associated with the risk events.
